(19) United States
(12) Patent Application Publication
(10) Pub. No.: US 2008/0004935 A1
(43) Pub. Date: Jan. 3, 2008

(54) Combined corporate philanthropy and employee recruiting model

(76) Inventor: Charles T. Marshall, Atherton, CA (US)

Correspondence Address: RICHARD B. MAIN, ESQ.;PATENTS PENDING, 9832 LOIS STILTNER CT., ELK GROVE, CA, 95624, US

(21) Appl. No.: 11/478,758

(22) Filed: Jun. 29, 2006

(51) Int. Cl. G06F 9/46

(52) U.S. Cl. 705/9

(57) ABSTRACT

A method for structuring and allocating referral and other incentive and donation payments and credits to users that include principals, referrers, candidates, not-for-profits, and other third parties. A recruiting business model allows an employer to set and publish job offerings with employee-recruitment bonuses that include obligations to make specific philanthropic donations to third-parties upon at least one of a candidate being interviewed, offered-the-job, hired, or retained for a minimum time. Job applicants can receive information related to the job offerings with employee-recruitment bonuses, and to accept the job, and to accept or negotiate the employee-recruitment bonuses. They may also request specific philanthropic donations to third-parties.

### BACKGROUND OF THE INVENTION

1. Field of the Invention

The present invention relates to contacts networking and incentive systems, and more particularly to automated candidate and prospect referral systems that induce employers and employee-candidates by rewarding their respective philanthropy agendas.

2. Description of Related Art

Very often the needs of an organization outstrip their abilities to find suitable candidates. This is true for employers trying to find qualified workers, for charitable organizations to find donors, for creditors to find debt-collection agents to get debtors to pay their bills, for researchers to find suitable clinical trial candidates, for law enforcement to find tipsters willing to respond to rewards, etc. So organizations have resorted in the past to the use of incentives and incentive programs that are not automated, difficult to administer, and limited in the populations they reach.

Many campaigns to find the needed resources are infrequent or rare events that do not justify a full-time, in-house staff. But at the same time, these campaigns demand high quality candidates that do not respond to traditional forms of marketing and advertising.

Nurses, for example, are in very high demand worldwide and attracting qualified candidates requires special efforts and contacts. What is needed are networks for allowing employers posting job openings, potential job candidates and potential referrers of candidates to electronically communicate their preferred compositions and distributions of any incentive elements related to payments for candidate referrals and hires.

Typically, an employer or recruiter today offers a standardized, but non-automated, referral bonus to their current employees, or perhaps extends the incentive to “friends of the company” or business associates. These may be former employees or current vendors or strategic partners, or the general public.

### SUMMARY OF THE INVENTION

Briefly, a system embodiment of the present invention is hosted on a web server and provides for recruitment, referral, and philanthropy campaigns. Users on the Internet with browsers log-on as clients to post and refer charitable donations or job opportunities, for example. At the heart of the server is an incentive engine that tracks job openings or other offerings by their ID, incentive type, and the value of the incentive. Incentives can be structured as cash bonuses, days off, contest points, etc. Combinations of incentives can be tailored to suit particular persons or groups. Users can post new jobs, make direct referrals to collect the entire hiring incentive, or pass along the information to their private contacts to share later in the incentives. The communication between these people is based on email and their respective email contact lists. The system tracks who-knows-who, and who-referred-who to who.

A recruiting business model allows an employer to set and publish job offerings with employee-recruitment bonuses that include obligations to make specific philanthropic donations to third-parties upon at least one of a candidate being interviewed, offered-the-job, hired, or retained for a minimum time. Job applicants can receive information related to the job offerings with employee-recruitment bonuses, and to accept the job, and to accept or negotiate the employee-recruitment bonuses. They may also request specific philanthropic donations to third-parties.

An advantage of the present invention is a referral network is provided where each user can align themselves with various philanthropic agendas that may appeal to prospective employees and employers.

Another advantage of the present invention is that a contact network is provided that automates and leverages Candidate Referral Programs. Messages are personal, dynamic, actionable, and customizable rich-text HTML emails which can include graphics, animation files, colors, and unique incentive management capabilities.

A still further advantage of the present invention is that a contacts networking technology is provided with individual account access for each participant, automated incentive creation and management, embedded email address manager, viral forwarding functionality, ability to automatically refer a candidate, resume storage and handling, directory service to locate current email addresses, real time referral tracking for all responses, multilevel organization admin features, auto non-duplicate email detection and handling, etc.

Another advantage of the present invention is that a contact network is provided that allows an employer, recruiter or sponsor to set up their own campaigns, e.g., naming the campaign, its duration, the position description or marketing message, etc. An administrator decides the starting and any ending dates of the campaign. If the employer wishes to include a bonus to encourage membership recruitment, they can select a rule from standard challenge rules provided, and then separately define the rule parameters.

A further advantage of the present invention is that a contact network is provided with incentive methods that include a direct bonus, where a one-time bonus is awarded to the person directly responsible for fulfilling the campaign goal, or allowing the referral agents to share the bonus, where users may elect to share all or part of the provided bonus with their contacts as incentive for campaign participation. Incentives can be structured in any units as defined by the employer within the application, e.g., dollars, time off, points, coupons, volunteer hours, etc.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIGS. 1A and 1B are flowchart diagrams of a candidate hiring, referral, and bonus system in an employer business model embodiment of the present invention;

FIGS. 2-11 are flowchart diagrams of a candidate hiring, referral, and bonus system in an employee-candidate business model embodiment of the present invention, in particular:

FIG. 2 is a flowchart diagram of a user log-in/sign-up process that allows users to set various preferences for bonus award recipients and amounts;

FIG. 3 is a continuing flowchart diagram of the user process of FIG. 2, and such allows users to view job postings, refer candidates, or respond themselves;

FIG. 4 is a flowchart diagram of a subroutine for the user process of FIG. 3, and such subroutine allows users to dictate desired bonuses, identify/describe candidates, tickle employer for interest, negotiation, etc;

FIGS. 5 and 6 are continuing flowchart diagrams of the user process of FIG. 3, and such allows users to see, if not shielded, who is the referrer, what are the bonus amounts, and to suggest other bonuses, and to attach user bonus preferences to a job application;

FIG. 7 is a continuing flowchart diagram of the user process of FIG. 6, and such allows employers to review applicants' resumes, applicants to accept or negotiate bonus terms, extend offers, hire the candidate, and issue activity reports;

FIG. 8 is a continuing flowchart diagram of the user process of FIG. 7, and such computes a hired applicant's bonus;

FIG. 9 is a continuing flowchart diagram of the user process of FIG. 8, and such calculates the awards due according to preferences set by the user;

FIG. 10 is a continuing flowchart diagram of the user process of FIG. 9, and such calculates the users' bonus payments;

FIG. 11 is a continuing flowchart diagram of the user process of FIG. 10, and such determines the donation payments that are to be made by the employers; and

FIG. 12 is a functional block diagram of a contacts networking technology system embodiment of the present invention, and which is suitable for hosting network programs described in FIGS. 1A, 1B, and 2-11.

### DETAILED DESCRIPTION OF THE INVENTION

Some employers will not wish to make any or all of their hiring payment elements visible. A new scheme is provided here that allows employers/recruiters to adjust online job listings to show some or all of the bonuses that may attach to a new hire. These bonuses can include referral bonuses to be paid for interviews, for hires, for signing, etc. Bonuses can be paid to the new hire for early signing, and retention bonuses can be paid after the new hire completes a fixed period on the job. Employers may also want to make private those donations that have been directed to be made to any third-party or not-for-profit organizations associated with the job listing.

The employer would then be able to identify which of these bonus categories would be eligible for “blending” or negotiating by a potential recruiter, referrer or candidate, individually coordinated within the Peeramyd software. There is a “wild card” functionality that allows a potential referrer to propose a bonus amount when submitting an identity-shielded candidate profile. For example, a potential referrer may have an exceptional candidate to refer but the posted bonus amount going to the referrer is currently too small to be attractive to the referrer. If the employer has posted a way for the referrer to suggest a larger share of the total available from the five job bonuses, the employer may agree to change the structure of the payout after viewing an identity shielded profile of the potential candidate submitted by the referrer. The referrer, in fact, may be a professional recruiter, and not just a friend or associate of the potential candidate. Employers may accept the suggested bonus amount, or negotiate an acceptable amount with the referrer within the application. The employer may also want assurances that any shifts in bonus payments will be acceptable to the potential candidate, and may require the potential referrer to clear that with their candidate before proceeding to an interview.

An employer may also provide a fixed donation amount to a professional association or non-profit organization that may be publicizing the job opening or helping to source referrers or candidates.

For example, an applicant is given the opportunity to structure the amounts of the bonuses awarded by giving a percentage to referrers and/or affiliates. The affiliate share of the bonus award is paid by the employer to an organization who posts the job on their site or otherwise publishes it to their membership. Applicants may forgo part or all of their entitled signing or retention bonuses in order to donate a portion of their earnings. E.g., to an affiliate and/or the individual who referred them to the position. Similarly, referrers may choose to donate a portion of their referral bonuses to an affiliate.

The system enables all three parties to disclose any preferred beneficiary not-for-profits or other third parties to become beneficiaries of any incentives related to the sourcing, interviewing, hiring, retention, or other career related activities associated with online job postings or job boards. The system process can include a database of approved or preferred affiliates.

Employers can thereby closely align and satisfy their corporate philanthropy objectives and specific targeted not-for-profit organizations with their recruiting efforts.

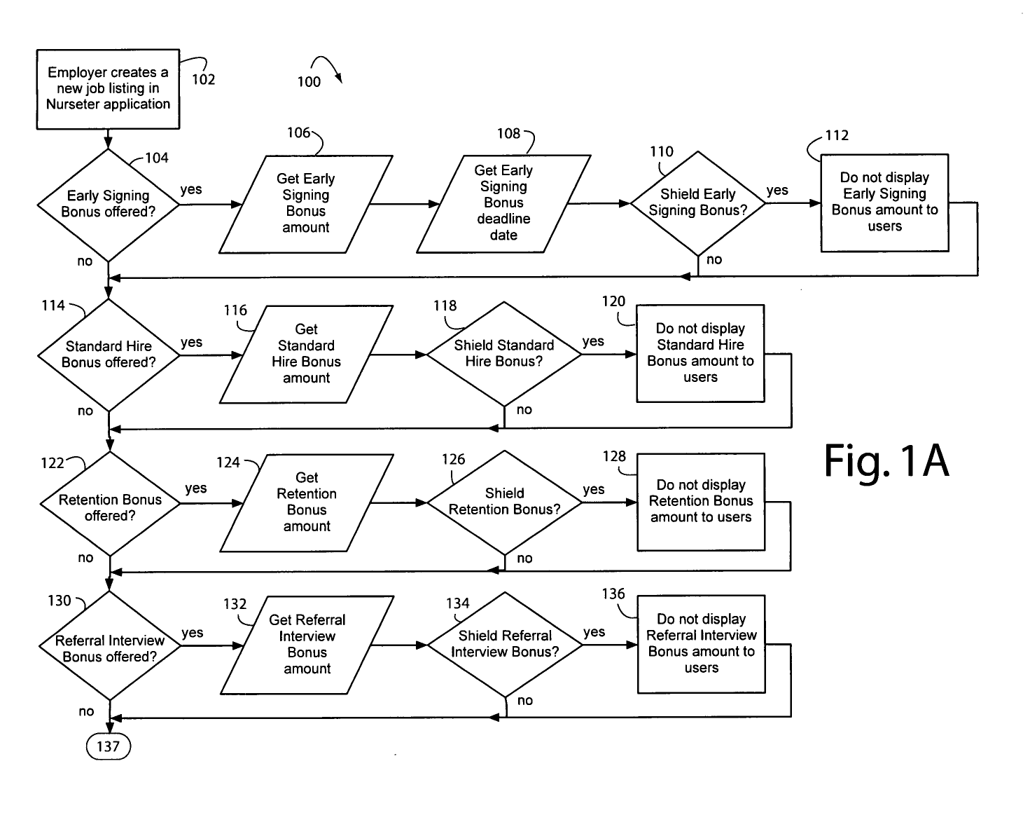

FIGS. 1A and 1B represent a candidate hiring, referral, and bonus system in an employer business model embodiment of the present invention, and is referred to herein by the general reference numeral 100. The employer business model 100 allows an employer (ER) to create and publish a new job listing in a step 102, e.g., a “Nurseter application” for recruiting nurses. The employer is asked in a step 104 if an early signing bonus is offered. If so, a step 106 gets the amount offered, a step 108 gets the deadline. A step 110 asks if the early signing bonus information is to be hidden from non-authorized users. If so, a step 112 sets a hidden flag in the database. The employer is asked in a step 114 if a standard signing bonus is offered. If so, a step 116 gets the amount, and a step 118 asks if the standard signing bonus information is to be hidden from non-authorized users. If so, a step 120 sets a hidden flag in the database. The employer is asked in a step 122 if a retention bonus is offered. If so, a step 124 gets the amount, and a step 126 asks if the retention bonus information is to be hidden from non-authorized users. If so, a step 128 sets a hidden flag in the database. The employer is asked in a step 130 if an interview bonus is offered. If so, a step 132 gets the interview bonus amount, and a step 134 asks if the retention bonus information is to be hidden from non-authorized users. If so, a step 136 sets a hidden flag in the database.

Referring now to FIG. 1B, and passing through a connector 137, the employer is asked in a step 138 if a referral hire bonus is offered. If so, a step 140 gets the referral hire bonus amount, and a step 142 asks if the bonus information is to be hidden from non-authorized users. If so, a step 144 sets a hidden flag in the database. The employer is asked in a step 146 if a job posting donation is offered. If so, a step 148 gets the donation amount, and a step 150 asks if the donation information is to be hidden from non-authorized users. If so, a step 152 sets a hidden flag in the database. The employer is asked in a step 154 if a candidate interview donation is offered. If so, a step 156 gets the candidate interview donation amount, and a step 158 asks if the candidate interview donation information is to be hidden from non-authorized users. If so, a step 160 sets a hidden flag in the database. The employer is asked in a step 162 if a candidate hire donation is offered. If so, a step 164 gets the candidate hire donation amount, and a step 166 asks if the candidate hire donation information is to be hidden from non-authorized users. If so, a step 168 sets a hidden flag in the database. A step 170 posts, or publishes the job, and the bonus and donation information to subscribers.

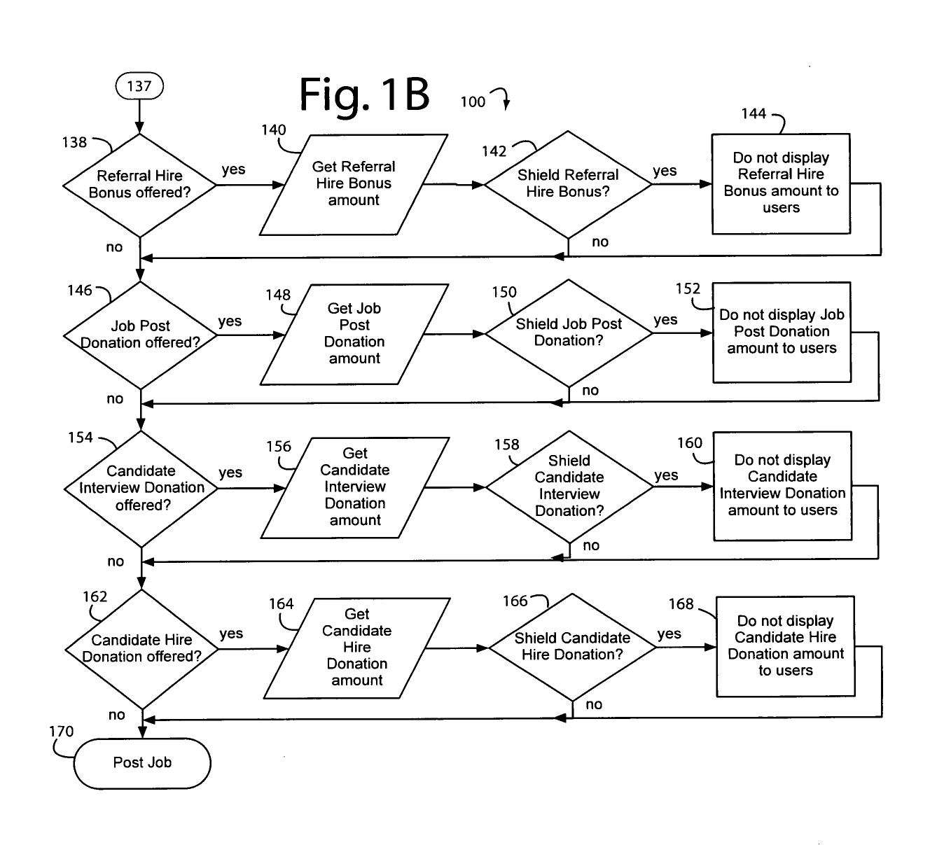

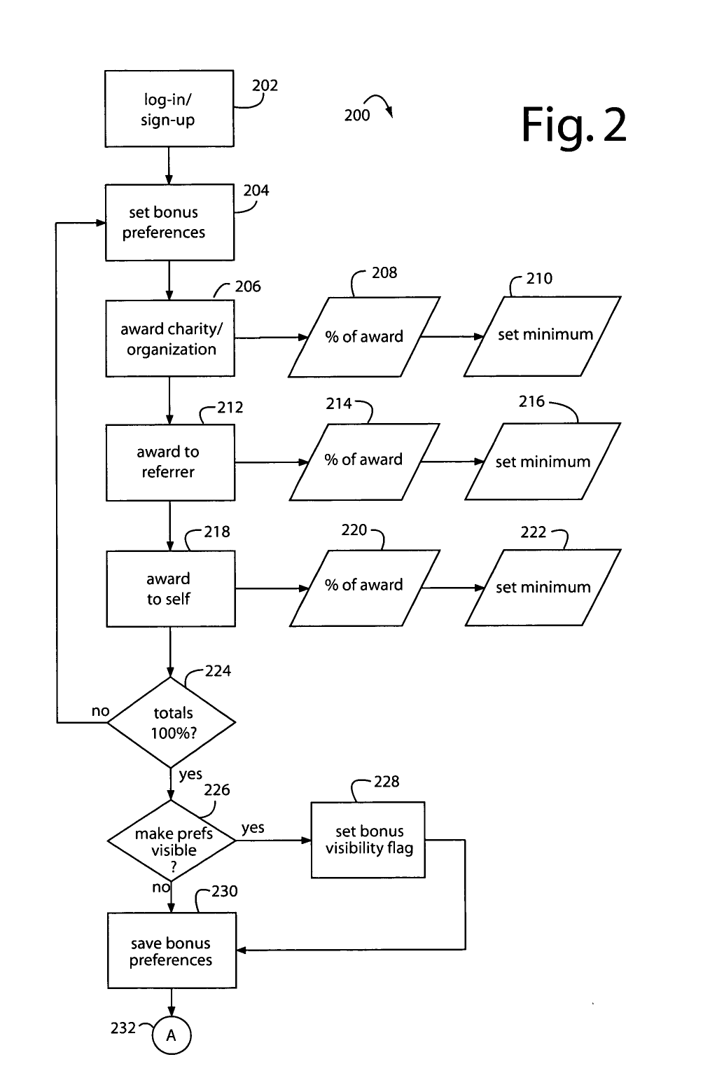

FIGS. 2-11 represent a candidate hiring, referral, and bonus system in an employee-candidate business model embodiment of the present invention. Such interacts with the employer referred to in FIGS. 1A and 1B, e.g., business model 100.

FIG. 2 represents a user log-in/sign-up process 200 that allows users to set various preferences for bonus award recipients and amounts. Users may log-in or sign-up in a step 202. Their bonus preferences can be set in a step 204. If there is a charity or other organization to be give a philanthropic award, then a step 206 allows a step 208 to set the percentage, and a step 210 to set a minimum award. A step 212 asks if an award is to be made to a referrer, and if so a step 214 sets the percentage and a step 216 sets any minimum amount. A step 218 asks if an award is to be made to oneself, and if so a step 220 sets the percentage and a step 222 sets any minimum amount. A step 224 tests to see if all the awards total 100% of the budget. If so, a step 226 asks if these preferences should be made visible. If yes, a step 228 sets a visibility flag. A step 230 saves the bonus preferences. A connector-A 232 links to the next process 300.

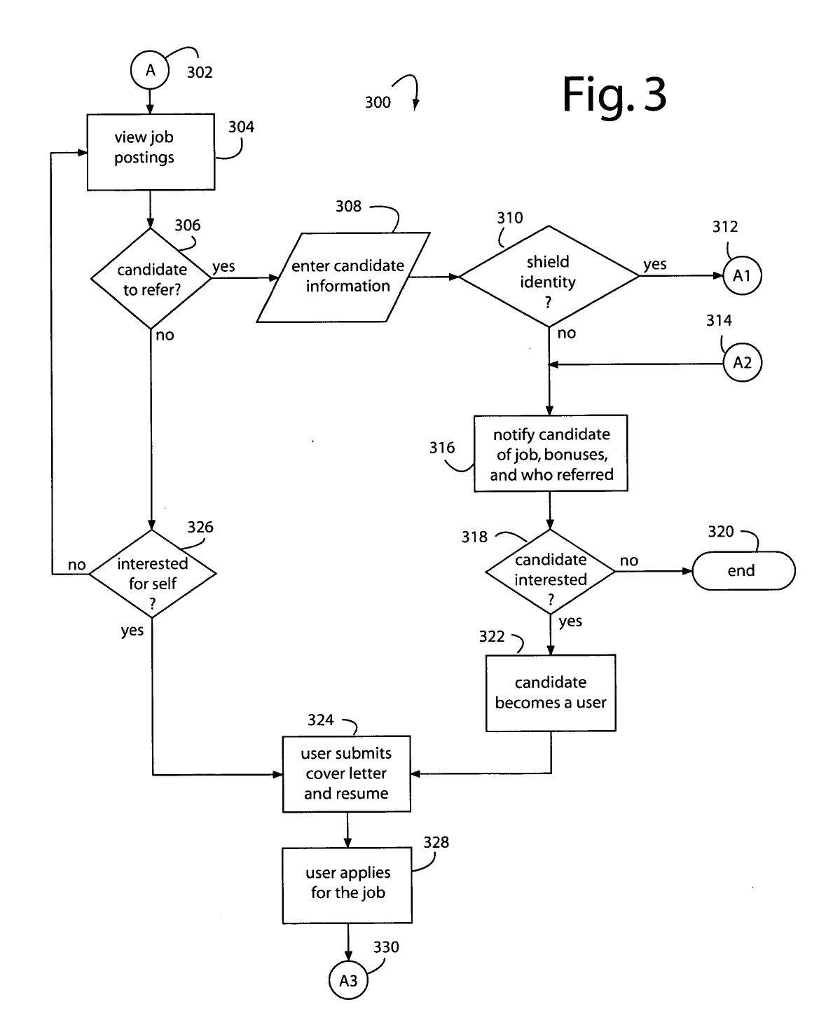

FIG. 3 represents a continuation 300 of the user process of FIG. 2, and such allows users to view job postings, refer candidates, or respond themselves. A connector-A 302 links from process 200. Users are allowed to view job postings in a step 304. A step 306 asks the user if they have a candidate to refer. If so, a step 308 allows the candidate's information to be entered. A step 310 asks if the candidate's identity is to be hidden. If so, a connector-A1 312 links to sub-routine 400 and returns with a connector-A2 314. The candidate is notified of the job, the bonuses, and who referred them, all in a step 316. A step 318 asks, e.g., in an email, if the candidate is interested in the job. If not, the process ends in link 320. Otherwise, the candidate now signs on as a user in a step 322. A cover letter and resume are submitted in a step 324. If in step 306 the user has no candidate to refer, then a step 326 asks if they themselves are interested in the job. If yes, then they proceed to step 324. Users then apply for the posted job and its bonuses in a step 328. A connector-A3 links to process 500.

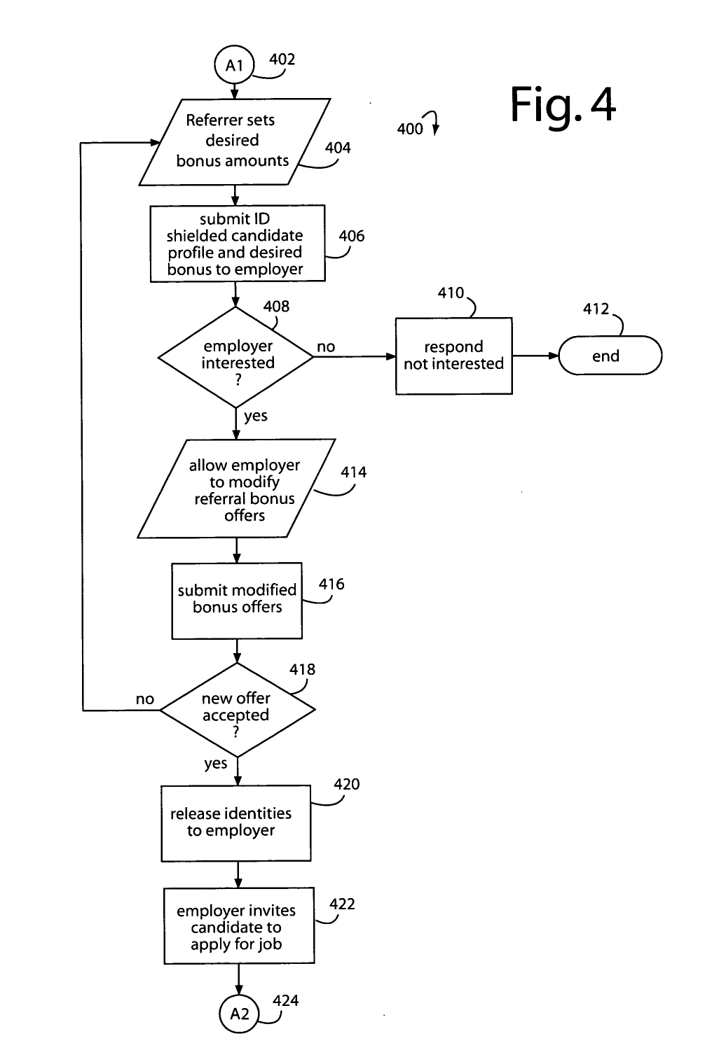

FIG. 4 represents a subroutine 400 for the user process 300 of FIG. 3, and such subroutine allows users to dictate desired bonuses, identify/describe candidates, tickle employer for interest, negotiation, etc. A connector-A1 402 passes to a step 404 that allows a user to set their desired bonus amounts. Step 406 provides identification hidden candidate profiles to be submitted to employers. A step 408 asks the employer if they are interested in this candidate. If not, a not-interested response is issued in a step 410 and passes to and end-process 412. Otherwise, a step 414 allows the employers to modify referral bonus offers if necessary. A step 416 submits the new package to the user. A step 418 asks if these new terms are acceptable. If yes, then a step 420 releases the candidate's identity to the employer. The candidate is invited to formally apply for the job in a step 422. A connector-A2 links to process 300.

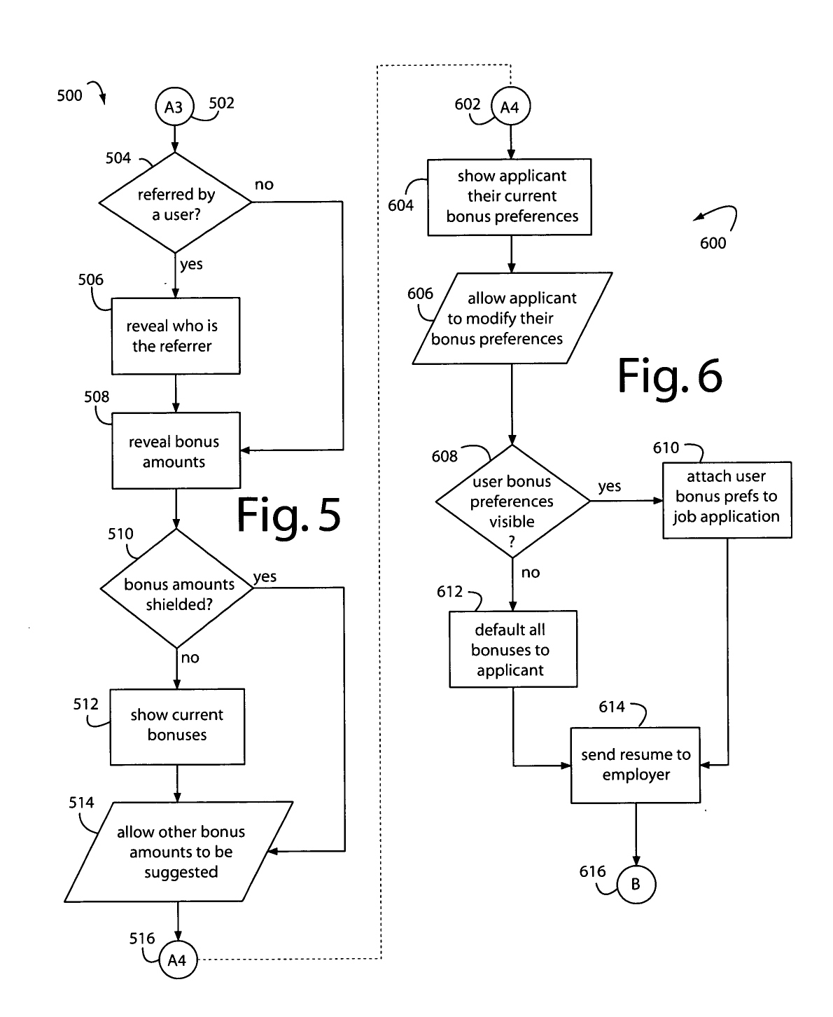

FIGS. 5 and 6 are continuations 500 and 600 of user process 300 of FIG. 3, and such allows users to see, if not shielded, who is the referrer, what are the bonus amounts, and to suggest other bonuses, and to attach user bonus preferences to a job application. A connector-A3 502 links to a step 504 which asks if the candidate was referred by a user. If yes, a step 506 reveals who is the referrer. A step 508 fetches the bonus amounts. A step 510 tests f these are shielded, and if not a step 512 shows them to the user. A step 514 allows other bonus amounts or structures to be suggested, e.g., to the referrer or the employer. A connector-A4 516 links to a connector-A4 602 in FIG. 6. A step 604 shows the applicant their current bonus preferences. A step 607 allows these to be changed. A step 608 asks if these bonus preferences should be visible. If yes, a step 610 attaches the bonus preferences to the job application. Otherwise, a step 612 defaults all bonuses to the applicant. A step 614 sends the resume to the employer. A connector-B 616 links to process 700.

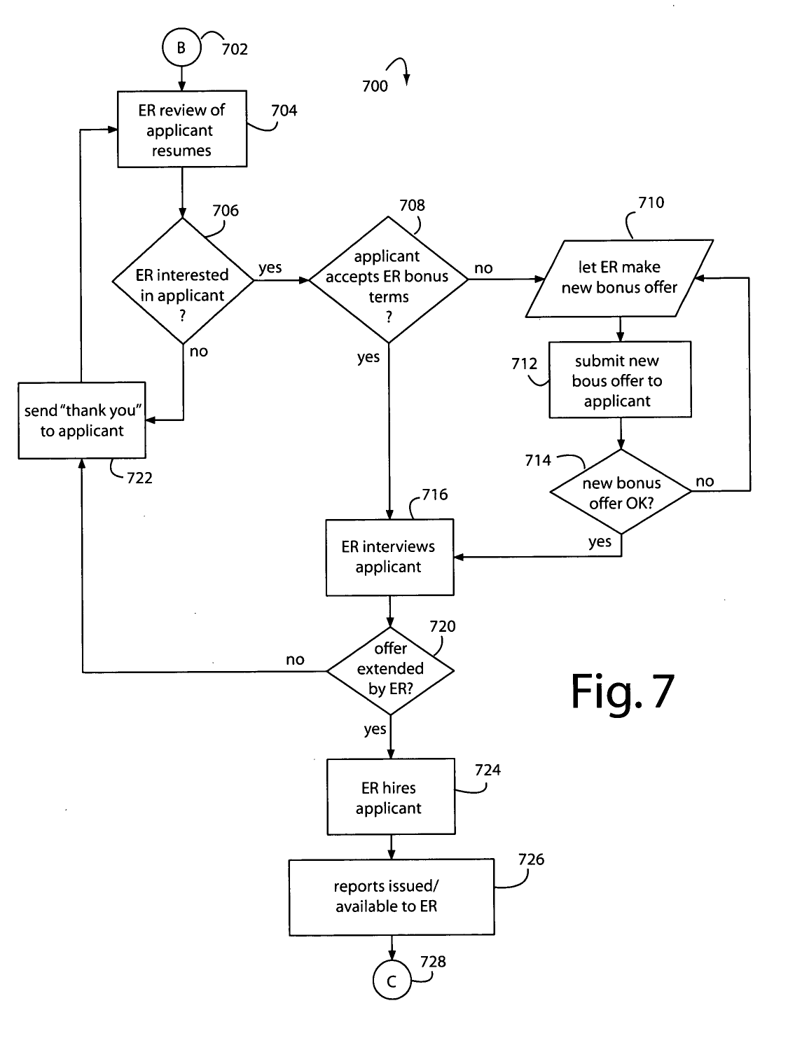

FIG. 7 is a continuation 700 of the user process 600 of FIG. 6, and such allows employers to review applicants' resumes, applicants to accept or negotiate bonus terms, extend offers, hire the candidate, and issue activity reports. A connector-B 702 links to a step 704 that allows the employer (ER) to review the applicants' resumes. A step 706 asks if the ER is interested in the candidate. If yes, a step 708 tests to see if the applicant accepts the bonus terms as is. If not, a step 710 lets the ER make a new bonus offer. A step 712 sends this to the applicant. A step 714 sees if this new bonus is acceptable. If yes, a step 716 allows the ER to interview the applicant. A step 720 sees if an offer is extended by the ER to the applicant. If not, a step 722 sends a “thank you” note to the applicant. If the offer was extended, then a step 724 represents hiring the applicant. A number of reports are then issued documenting the job, applicant, users, referrers, bonuses, etc. A connector-C 728 leads to process 800.

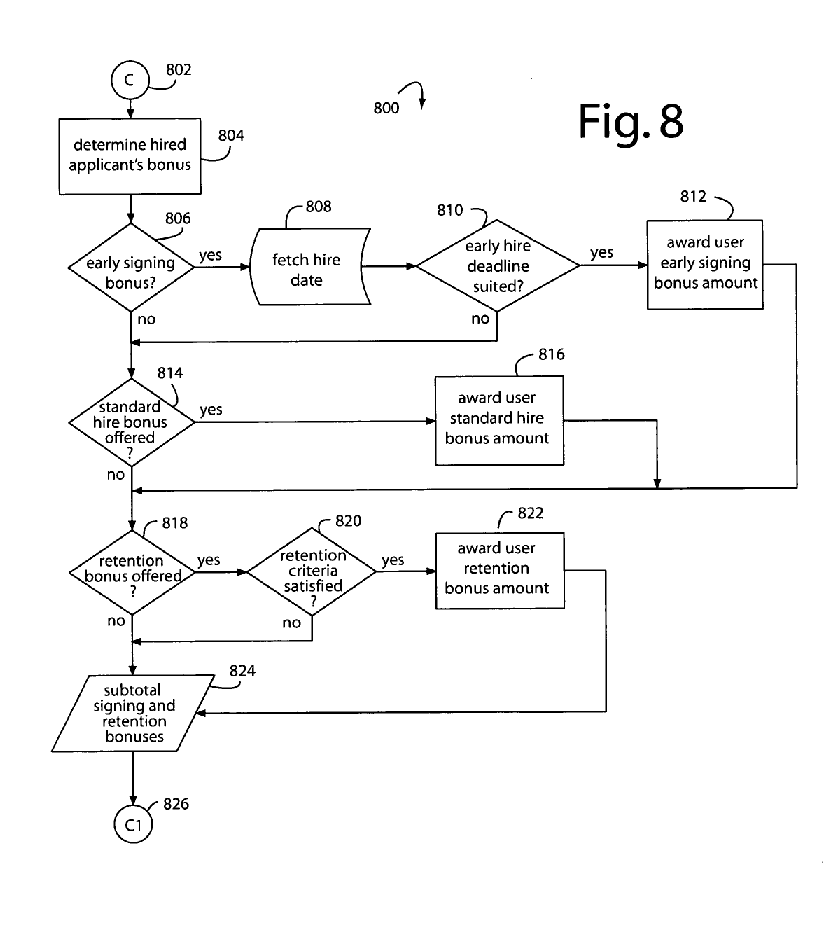

FIG. 8 is a continuation 800 of the user process 700 of FIG. 7, and such computes a hired applicant's bonus. A connector-C 802 from FIG. 7 leads to a step 804 for determining a hired applicant's bonus. A step 806 asks if an early signing bonus had been set-up. If so, a step 808 fetches the hiring date. A step 810 asks if the hire date beat the deadline. If so, a step 812 awards the early signing bonus amount. A step 814 asks if the standard hire bonus was offered, and if so a step awards the user that amount. A step 818 asks if a retention bonus was offered. If so, a step 820 tests to see if the applicant has been employed for at least the minimum threshold time. If yes, then a step 822 awards a retention bonus. A step 824 then calculates a subtotal for all these bonuses in process 800. A connector-C1 826 links to process 900.

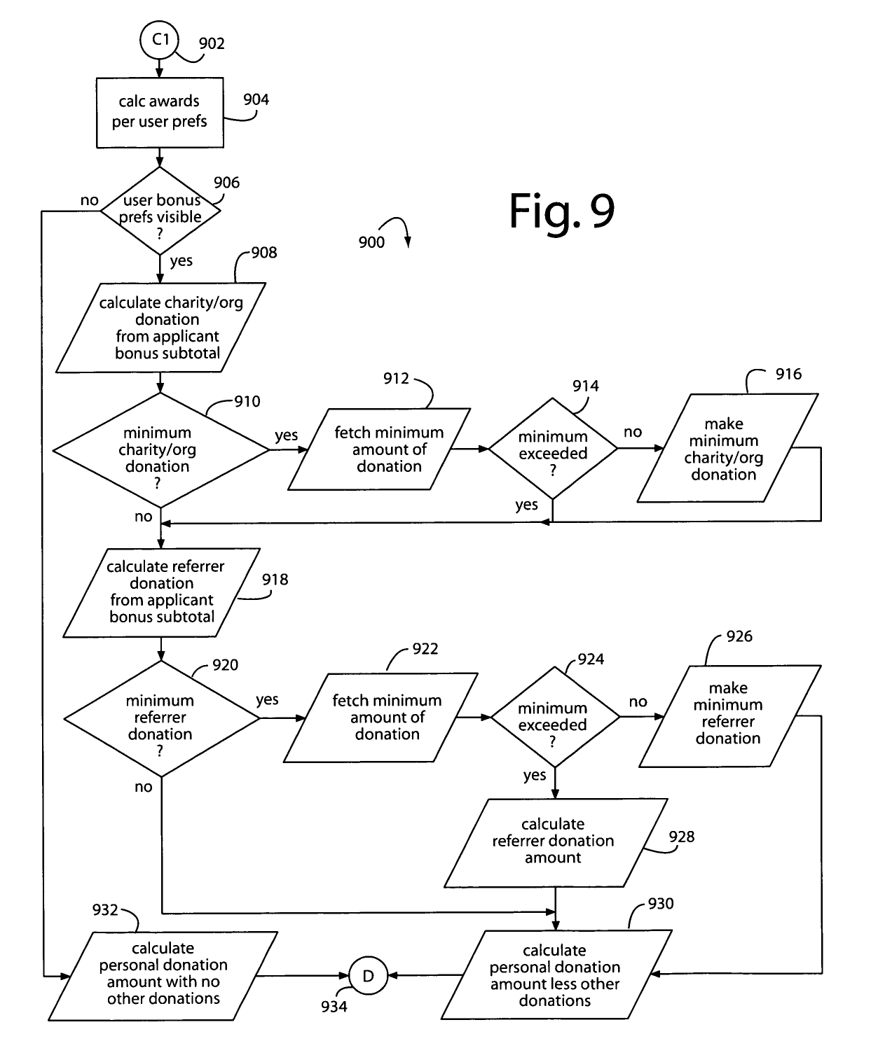

FIG. 9 is a continuation 900 of the user process 800 of FIG. 8, and such calculates the awards according to preferences set by the user. A connector-C1 902 links to a step 904 to calculate the awards given the users' preferences. A step 906 asks if the user's preferences are visible. If yes, then a step 908 calculates the philanthropic donations from the applicant's subtotal bonus amount. A step 910 asks if there is a minimum charity/organization donation amount. If so, a step 912 fetches what is to be the minimum. A step 914 sees if this minimum was exceeded. If not, a step 916 makes the minimum amount. A step 918 calculates the referrer donation given the bonus qualified for by the applicant. A step 920 looks to see if a minimum applies. A step 922 fetches the minimum. A step 924 tests if the minimum was exceeded. If not, the minimum is fixed as the correct amount. A step 928 calculates the referrer donation amount. A step 930 calculates the personal donation amount. If the user bonus preferences were not visible in step 906, then a step calculates the personal donation. A connector-D 934 links to process 1000.

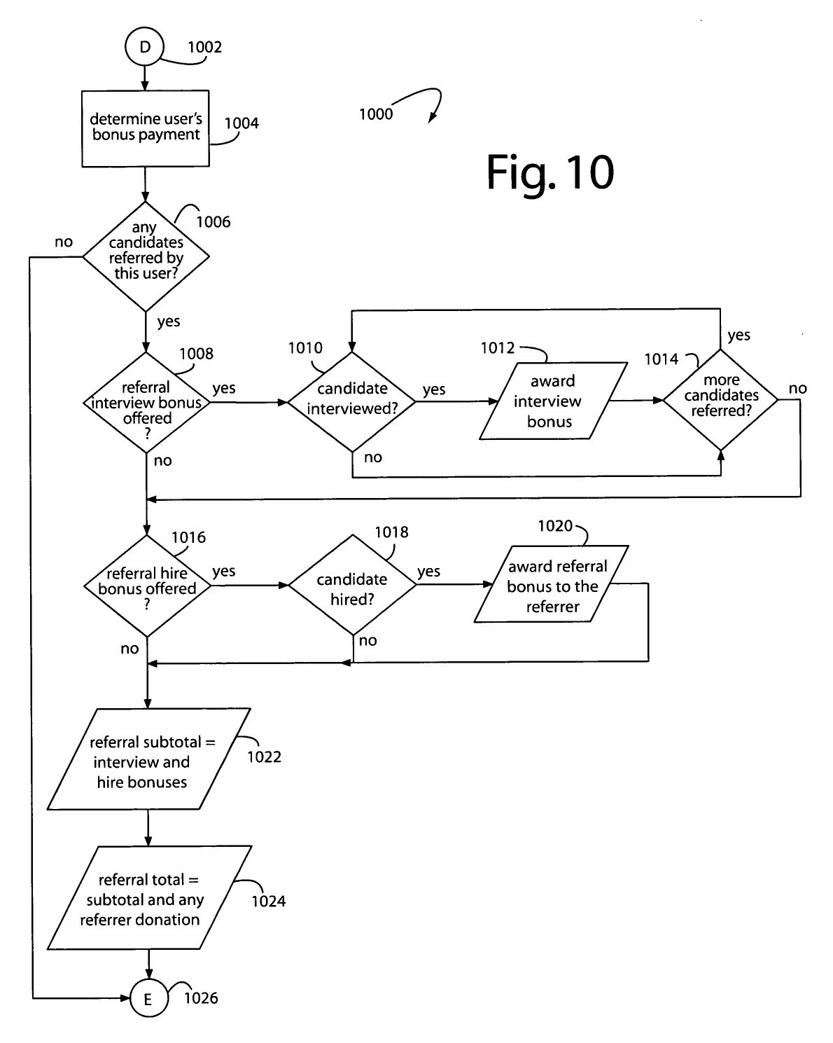

FIG. 10 is a continuation 1000 of the user process 900 of FIG. 9, and such calculates the users' bonus payments. A connector-D 1002 links to a step 1004 for determining a user's bonus payment. A step 1006 asks for any candidates referred by this user. If so, a step 1008 asks if a referral interview bonus was offered. If so, a step 1010 asks if the candidate was interviewed. If yes, a step 1012 awards the interview bonus. A step 1014 looks to see if more candidates were referred by this user. If not, a step 1016 tests if a referral hire bonus was offered. If yes, a step 1018 sees if the candidate was hired. If so, a step 1020 awards a referral bonus to the referrer. Then a step 1022 finds the subtotal of the interview and hire bonuses. A step 1024 calculates the referrer donation and takes a connector-E 1026 to process 1100.

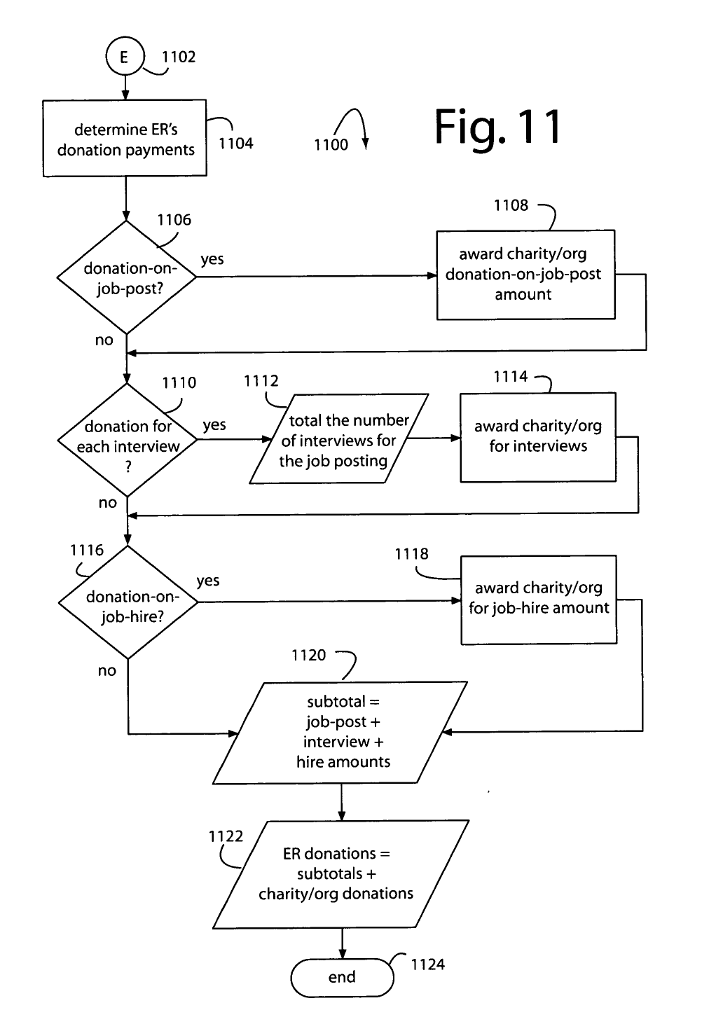

FIG. 11 is a continuation 1100 of the user process 1000 of FIG. 10, and such determines the donation payments that are to be made by the employers. A connector-E 1102 links to a step 1104 for determining the employer's donation payments, e.g., its philanthropy tied to hiring activities. Such philanthropy can induce a candidate to accept a job offer because the employer is viewed as a good corporate citizen and a good place to work. A step 1106 checks for a donation on posting of the job, e.g., listing the job on a philanthropic organization's website or literature. If yes, a step 1108 awards the posting amount. A step 1110 sees if a donation is to be awarded for there having been a job interview. If so, a step 1112 totals the number of interviews completed for the job posting. A step 1114 awards the set amount. A step 1116 looks to see if an award is to be paid for filling the job. If yes, a step 1118 awards in the job-hired amount previously set. A step 1120 finds a subtotal for the job-post, job-interview, and job-hire donation amounts. A step 1122 computes these donation subtotals and the charity/organization for a total to be paid. A step 1124 ends process 1100.

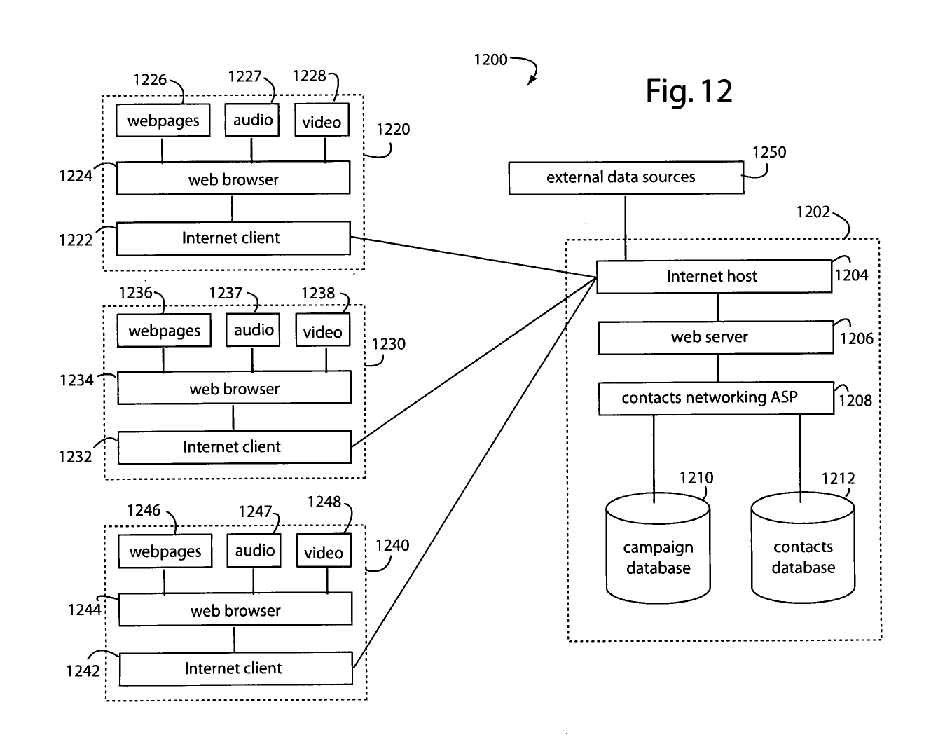

FIG. 12 illustrates a contacts networking technology system embodiment of the present invention, and is referred to herein by the general reference numeral 1200. Such includes a viral email networking software platform to help participants of employee and member referral programs leverage their social, corporate and business community contacts. The contacts networking technology system 1200 provides personalized individual account access for each participant. The system 1200 comprises a business 1202 with an Internet host 1204, a web server 1206, a contacts networking ASP or PHP application 1208, and a database, e.g., a campaign database 1210 and a contacts database 1212. These two databases can be consolidated into one. The Internet host 1204 is visible to a user 1220 with an Internet client 1222 and a web browser 1224 able to interact with webpages 1226, audio 1227, and video media 1228. Similarly, the Internet host 1204 is accessible to an administrator 1230 with an Internet client 1232 and a web browser 1234 able to interact with webpages 1236, audio 1237, and video media 1238. The Internet host 1204 is hyperlinked to a referral 1240 with an Internet client 1242 and a web browser 1244 able to interact with webpages 1246, audio 1247, and video media 1248. Such referral was not originally known to business 1202, but was introduced by user 1220 and can thereafter participate in campaigns and incentives. System 1200 can limit email communications to particular domains.

Embodiments of the present invention include a method of structuring and allocating referral, and other incentive and donation payments, and credits to users of the system including principals, referrers, candidates, not-for-profits, and other third parties. Specific embodiments include those tailored to suit job boards, dating/matching services, relationship capital, and rewarding sales leads for major deals.

Alternative methods of publishing job openings in an aggregated fashion are starting to appear on the Internet, e.g., at www.indeed.com and www.simplyhired.com. These search engines charge no direct fees to the respective employers or employees, they survive on advertising revenue.

Beyond allowing employers to align their corporate social responsibility/philanthropy with recruiting, the present system also allows a shifting of fees previously paid to job opening publishers, referrers, and candidates, to be paid instead to favored not-for-profit organizations.

Although particular embodiments of the present invention have been described and illustrated, such is not intended to limit the invention. For example, the embodiments illustrated here have shown a job recruitment incentive contacts network. Modifications and changes will no doubt become apparent to those skilled in the art, and it is intended that the invention only be limited by the scope of the appended claims.

The invention claimed is:

1. A recruiting business model, comprising:
means for an employer to set and publish job offerings with employee-recruitment bonuses that include obligations to make specific philanthropic donations to third-parties upon at least one of a candidate being interviewed, offered-the-job, hired, or retained for a minimum time; and
means for a job applicant to receive information related to said job offerings with employee-recruitment bonuses, and to accept the job, and to accept or negotiate said employee-recruitment bonuses and to request specific philanthropic donations to third-parties.

2. The recruiting business model of claim 1, further comprising:
means for a referrer to receive information related to said job offerings with employee-recruitment bonuses, and to refer the job for a cut of specific bonuses to said job applicant, and to accept or negotiate said employee-recruitment bonuses and to request specific philanthropic donations to third-parties.

3. The recruiting business model of claim 1, further comprising:
shielding means providing for the hiding of specific terms in said employee-recruitment bonuses from being accessed by unauthorized users.

4. The recruiting business model of claim 1, further comprising:
preference setting means for adjusting said employee-recruitment bonuses to include rewards for at least one of a candidate being interviewed, offered-the-job, hired, or retained for a minimum time.

5. The recruiting business model of claim 1, further comprising:
preference setting means for changing the percentages to be paid for said employee-recruitment bonuses that include rewards for at least one of a candidate being interviewed, offered-the-job, hired, or retained for a minimum time.

6. A method comprising the structuring and allocating referral and other incentive and donation payments and credits to users of the system including principals, referrers, candidates, not-for-profits, and other third parties.

7. The method of claim 6, wherein such provides at least one of a job board, a dating/matching service, relationship capital, or sales leads for business deals.

8. The method of claim 6, further comprising:
enabling an employer to set and publish job offerings with employee-recruitment bonuses that include obligations to make specific philanthropic donations to third-parties upon at least one of a candidate being interviewed, offered-the-job, hired, or retained for a minimum time; and
providing for a job applicant to receive information related to said job offerings with employee-recruitment bonuses, and to accept the job, and to accept or negotiate said employee-recruitment bonuses and to request specific philanthropic donations to third-parties.

9. The method of claim 7, further comprising:
sending information to a referrer related to said job offerings with employee-recruitment bonuses, and referring the job for a cut of specific bonuses to said job applicant, and accepting or negotiating said employee-recruitment bonuses and requesting specific philanthropic donations to third-parties.

10. The method of claim 7, further comprising:
shielding of specific terms in said employee-recruitment bonuses from being accessed by unauthorized users.

11. The method of claim 7, further comprising:
adjusting said employee-recruitment bonuses to include rewards for at least one of a candidate being interviewed, offered-the-job, hired, or retained for a minimum time.

12. The method of claim 7, further comprising:
changing the percentages to be paid for said employee-recruitment bonuses that include rewards for at least one of a candidate being interviewed, offered-the-job, hired, or retained for a minimum time.
